(19) United States
(12) Patent Application Publication
(10) Pub. No.: US 2012/0321441 A1
(43) Pub. Date: Dec. 20, 2012

(54) VENTILATED COMPRESSOR ROTOR FOR A TURBINE ENGINE AND A TURBINE ENGINE INCORPORATING SAME

(76) Inventors: Kenneth MOORE, Greenville, SC (US); Narendra Are, Greenville, SC (US); Matthew Ferslew, Greenville, SC (US); Seung-Woo Choi, Greenville, SC (US); John Blanton, Greenville, SC (US)

(21) Appl. No.: 13/163,966

(22) Filed: Jun. 20, 2011

(51) Int. Cl. F01D 5/02; B23P 15/04

(52) U.S. Cl. 415/115; 29/889.2

(57) ABSTRACT

A turbine engine includes a plurality of compressor rotors that include ventilation slots to vent the spaces between adjacent compressor rotors. Each compressor rotor is formed from a flat disk of material having first and second circular faces. A circular ridge of material protrudes outward from the one of the circular faces of the disc adjacent an outer edge of the disc. The ventilation slots are formed in the circular ridge of material. Each ventilation slot is a depression in the circular ridge of material, the depression having a longitudinal axis that extends substantially in a radial direction of the disc.

### BACKGROUND OF THE INVENTION

The invention relates to rotors used in the compressor of a gas turbine engine.

The compressor section of a gas turbine engine used in power generation applications typically includes a plurality of disc-shaped compressor rotors which abut one another. A plurality of rotating compressor blades extend radially outward from the outer circumferential edge of each of the compressor rotors. Each compressor rotor is typically shaped such that circumferential flanges extend outward from both circular faces of the disc, the circumferential flanges being located adjacent the outer edge of the disc.

When plurality of compressor discs are stacked together to form the compressor section of a gas turbine engine, the circumferential flanges of adjacent compressor rotors abut one another. As a result, a cavity is formed between each adjacent pair of compressor discs, the cavity being located radially inward of the mating circumferential flanges.

Air or gases trapped in the cavity formed between adjacent compressor discs can act as a thermal insulator, which can result in temperature gradients between adjacent compressor discs. These temperature gradients can cause stress to develop between adjacent compressor discs. The temperature gradients can also negatively impact the tip clearance between the rotating compressor blades attached to the compressor discs and/or the compressor stator vanes.

During startup or shutdown of a gas turbine engine, thermal gradients between the various elements of the compressor section are inevitable. The thermal insulating effect of the air or gases trapped in the cavities between adjacent compressor rotor discs can extend the time that those thermal gradients exist, as well as increase the stress on the components of the compressor section, and possibly negatively impacting the rotor blade and/or stator vane clearances for an extended period of time.

In addition, when there is a temperature difference between a cavity located between adjacent compressor rotor discs and an area radially outward of the cavity, it is possible for a pressure gradient to develop between the cavities and the area radially outward of the cavities. This pressure gradient can also negatively impact compressor and turbine performance.

### BRIEF DESCRIPTION OF THE INVENTION

In one aspect, the invention could be embodied in a compressor rotor for a turbine engine that includes a disc of material having first and second circular faces, and a circular flange that protrudes outward from the first circular face of the disc adjacent an outer edge of the disc. At least one ventilation slot is located in the circular flange, the at least one ventilation slot comprising a depression in the circular flange, the depression having a longitudinal axis that extends substantially in a radial direction of the disc. The disc may also include a second circular flange that protrudes outward from the second circular face of the disc adjacent an outer edge of the disc, where at least one ventilation slot is located in the second circular flange, the at least one ventilation slot comprising a depression in the second circular flange, the depression having a longitudinal axis that extends substantially in a radial direction of the disc.

In another aspect, the invention could be embodied in a method of manufacturing a compressor rotor for a turbine engine. The method includes forming a disc of material having first and second circular faces and a circular flange that protrudes outward from the first circular face of the disc adjacent an outer edge of the disc. The method also includes forming at least one ventilation slot in the circular flange, the at least one ventilation slot comprising a depression in the circular flange, the depression having a longitudinal axis that extends substantially in a radial direction of the disc.

### BRIEF DESCRIPTION OF THE DRAWINGS

FIG. 1 is a partial cross-sectional view of the compressor section of a turbine engine;

FIG. 2 is a plan view of a first embodiment of a compressor rotor disc of a turbine engine;

FIG. 3 is a cross-sectional view of the rotor illustrated in FIG. 2 taken along section line III-III;

FIG. 4 is a top view of a portion of an edge of a compressor rotor disc of a turbine engine;

FIG. 5 is a perspective view of a portion of a compressor rotor disc of a turbine engine;

FIG. 6 is a plan view of an alternate compressor rotor disc of a turbine engine;

FIG. 7 is a plan view of another alternate compressor rotor disc of a turbine engine;

FIG. 8 is a perspective view of a portion of an alternate compressor rotor disc of a turbine engine;

FIG. 9 is a perspective view of a portion of an alternate compressor rotor disc of a turbine engine;

FIG. 10 is a perspective view of a portion of an alternate compressor rotor disc of a turbine engine;

FIG. 11 is a perspective view of a portion of an alternate compressor rotor disc of a turbine engine;

FIG. 12 is a perspective view of a portion of an alternate compressor rotor disc of a turbine engine;

FIG. 13 is a perspective view of a portion of an alternate compressor rotor disc of a turbine engine;

FIG. 14 is a perspective view of a portion of an alternate compressor rotor disc of a turbine engine

FIG. 15 is a perspective view of a portion of an alternate compressor rotor disc of a turbine engine; and

FIG. 16 is a perspective view of a portion of an alternate compressor rotor disc of a turbine engine.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

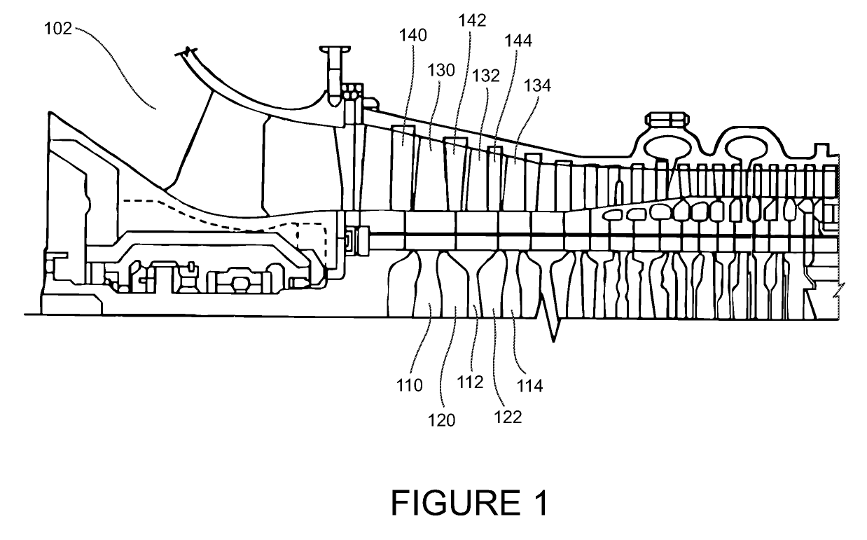

FIG. 1 illustrates the compressor section of a typical turbine engine which may be used in a power generating facility. The compressor section includes an inlet 102 which receives a flow of inlet air. The compressor section also includes alternating rows of stator vanes 140, 142, 144 and rotating compressor blades 130, 132, 134. The rotating compressor blades 130, 132, 134 are attached to the outer edges of disc shaped compressor rotor discs 110, 112, 114.

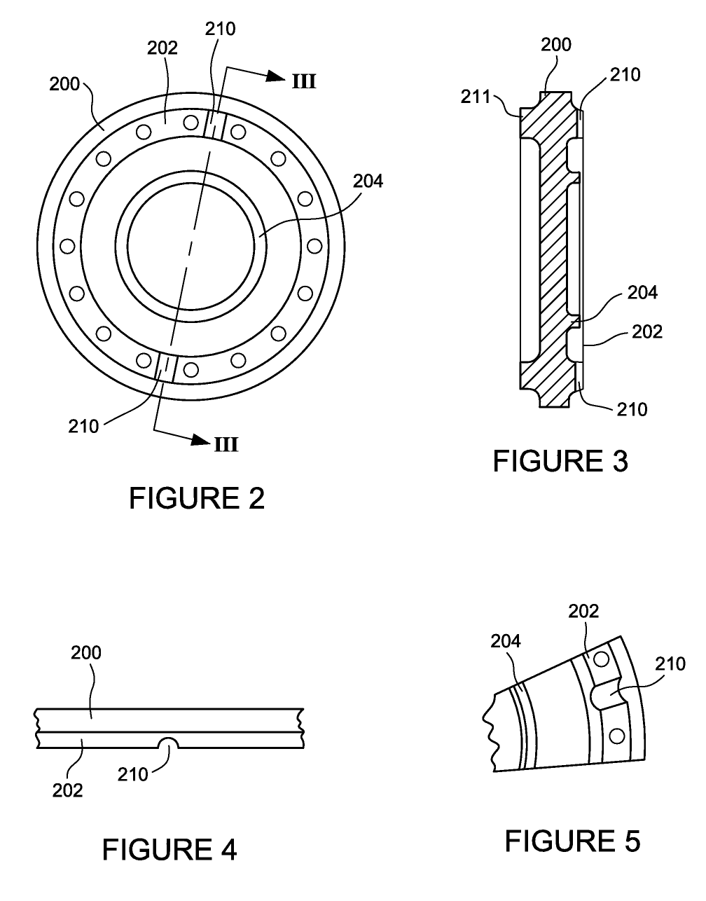

FIGS. 2 and 3 illustrate a compressor rotor disc without compressor blades mounted thereon. The compressor rotor disc includes a circular flange 202 that protrudes outward from a first circular face of the rotor adjacent an outer edge 200 of the rotor. The compressor rotor also includes a second circular flange 211 formed on the second opposite circular face of the disc adjacent the outer edge 200 of the rotor disc. This compressor rotor also includes a third circular flange 204 that protrudes outward from the first circular face and which is located radially inward of the first circular flange 202.

As illustrated in FIG. 1 a plurality of rotating compressor blades are mounted around the outer circumferential edge of each compressor rotor disc. As also illustrated in FIG. 1, a plurality of compressor rotors 110, 112, 114 are stacked together to form the inner portions of the compressor section. As a result, cavities 120, 122 are formed between adjacent compressor discs 110, 112, 114.

The cavities formed between adjacent compressor rotor discs can help to cause thermal and pressure gradients develop between the various elements of the compressor section. Those thermal and pressure gradients can negatively impact the life and performance of the compressor section and the turbine engine. The thermal gradients can induce stress in the elements of the compressor and negatively impact the clearances of the compressor rotating blades 130, 132, 134 and the stator vanes 140, 142, 144.

To help prevent thermal and pressure gradients from developing, one or more ventilation slots 210 may be cut in the circular flanges 202, 211 of the compressor rotor discs. The ventilation slots allow air or gas to freely flow back and forth between the cavities formed between adjacent compressor rotor discs and the areas located radially outward of the cavities.

The ventilation slots can take the form of elongated depressions that are formed or cut into the circular flanges 202, 211. FIG. 2 shows that a longitudinal axis of the ventilation slots 210 extend in a radial direction of the disc-shaped compressor rotor disc. The cross-sectional view provided in FIG. 3 illustrates that the ventilation slots 210 are depressions formed or cut into the circular flanges 202, 211. FIG. 4, which provides a top view of a portion of the outer edge of a compressor rotor discs, illustrates that the ventilation slot 210 can have a semi-circular shape.

FIG. 5 provides a perspective view of a portion of a compressor rotor which also illustrates a ventilation slot 210 formed in a circular flange 202 of the rotor. The ventilation slot 210 has a semi-circular shape, and a longitudinal axis of the ventilation slot 210 extends in a radial direction of the disc-shaped rotor disc.

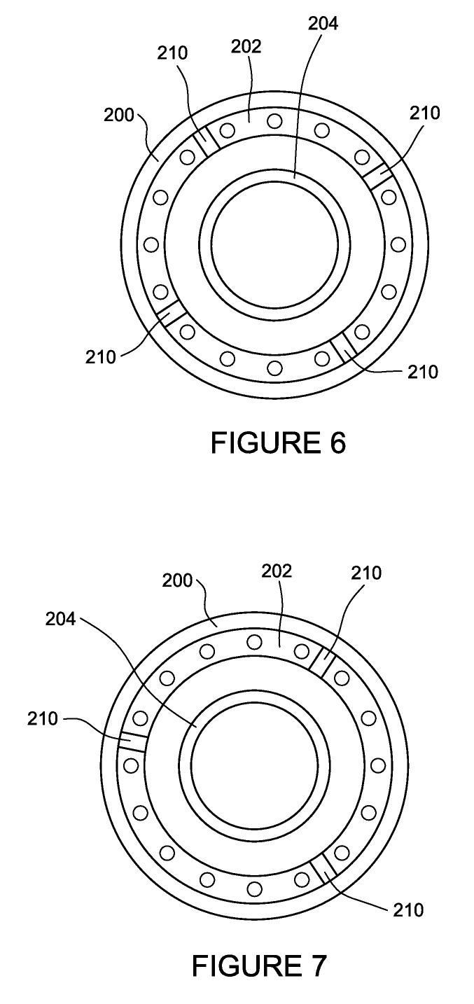

Although the embodiment illustrated in FIG. 2 includes two ventilation slots 210, alternate embodiments could have only a single ventilation slot, or more than two ventilation slots. FIG. 6 illustrates an embodiment having four ventilation slots 210. FIG. 7 illustrates another alternate embodiment having three ventilation slots 210. Other embodiments could have more than four ventilation slots.

In the embodiments illustrated in FIGS. 2, 6 and 7, the ventilation slots 210 are located substantially symmetrically around the circumference of the circular flange 202. However, in alternate embodiments, the ventilation slots could be located asymmetrically around the circumference of the compressor rotor disc.

A compressor section of a turbine engine could be formed such that each compressor rotor disc has ventilation slots in a circular flange on only one side face of the rotor disc. When a plurality of such compressor rotor discs are stacked together, the ventilation slots will ensure that the cavities formed between each adjacent pair of discs will be vented to the area radially outward of the cavities.

Alternatively, two different types of compressor discs could alternate with one another in a stack of rotors. The first type of compressor rotor would have no ventilation slots. The second type of rotor would have ventilation slots located in the circular flanges located on both side faces. This arrangement would also ensure that the cavities formed between each adjacent pair of rotors will be vented to the area radially outward of the cavities.

When a turbine engine having compressor rotor discs with ventilation slots is first put into operation, the various elements of the compressor section will all begin to heat up. Because the ventilation slots allow air or gases to flow into and out of the cavities between adjacent compressor rotor discs, no pressure gradients are likely to develop. Also, if one region becomes hotter than another region, the pressure of the gas in the hotter region will increase, which will cause gas from the hotter region to flow into an adjacent cooler (lower pressure) region. This movement of gas from a hotter region to a cooler region will help to reduce temperature gradients between different regions of the compressor section. And, as noted above, this will help to reduce thermally induced stress. This same process also occurs upon shutdown of the turbine engine when different regions will cool at different rates.

The number and size of the ventilation slots can be based on the volume of air that is expected to aspirate into or out of a cavity during startup or shutdown of a turbine engine. The volume of airflow, in turn, may be based on the cavity size, the location of the cavity in the compressor, the anticipated cavity surface temperatures, and the flow path of air or gas through the compressor. Thus, all of these factors could influence the number and location of the ventilation slots.

Properly designed ventilation slots will improve rotor life by reducing transient thermal and pressure gradients experienced by different portions of the compressor, and as between adjacent discs. The ventilation slots will also improve compressor efficiency by minimizing purged regions within the compressor. Providing ventilation slots is also expected to improve the predictability of rotor metal temperatures as compared to compressor rotors lacking ventilation slots. Further, upon startup and shutdown, the provision of ventilation slots is expected to reduce the time required before all elements of the compressor reach a stable, steady state operating condition.

Although FIGS. 2-5 illustrate ventilation slots having an elongated semicircular shape, the ventilation slots could have a variety of other shapes. For example, FIG. 8 shows an embodiment where a ventilation slot 210 is still rounded, but where the radially inward end of the ventilation slot is larger than the radially outward end of the ventilation slot 210.

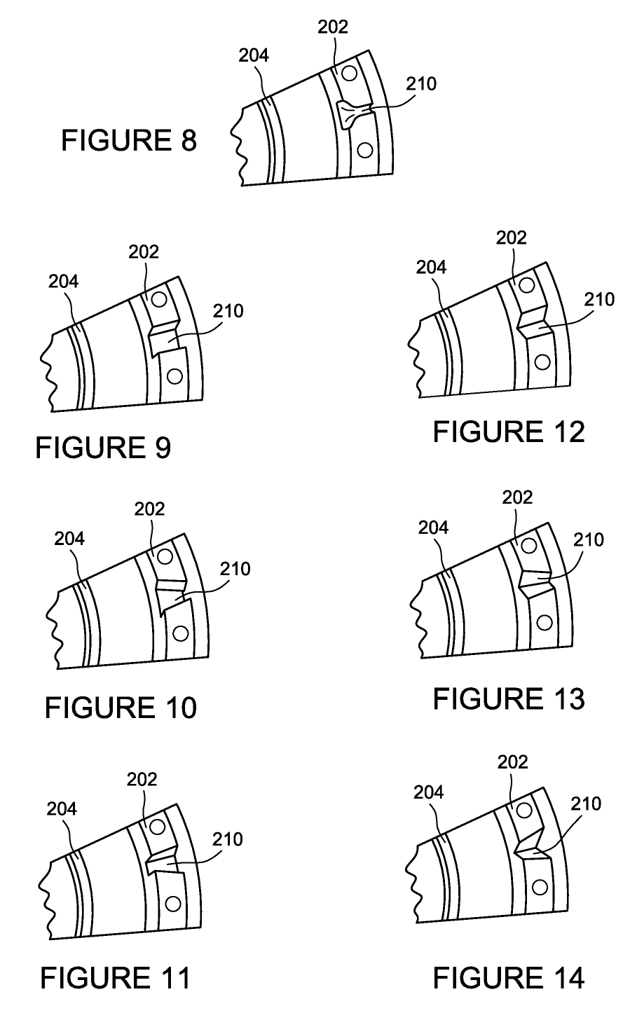

FIG. 9 illustrates a ventilation slot 210 having a square or rectangular profile. FIG. 10 illustrates a ventilation slot with a rectangular profile, but where the radially inward end of the ventilation slot 210 has a larger width than the radially outward end of the ventilation slot. Conversely, FIG. 11 illustrates an embodiment where the radially inward end of the ventilation 210 slot has a smaller width than the radially outward end.

FIG. 12 illustrates an embodiment where the ventilation slot 210 has a V-shaped profile. FIG. 13 illustrates a V-shaped ventilation slot 210 where the radially inward end is larger than the radially outward end. Conversely, FIG. 14 illustrates a V-shaped ventilation slot 210 wherein the radially inward end of the V-shaped slot is smaller than the radially outward end.

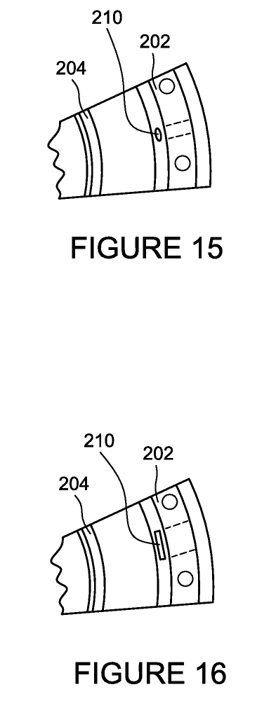

Although FIGS. 8-14 illustrate various alternatives, the ventilation slots could take on any other shape that still allows air or gases to aspirate into and out of the cavities formed between adjacent compressor rotor discs. For example, the ventilation slots could take the form of holes, channels or passageways that pass through a circular flange from the radially inner side of the flange to the radially outer side of the flange. FIG. 15 illustrates an embodiment where a cylindrical ventilation slot 210 is bored though the circular flange 202 between the inner and outer faces of the circular flange 202. FIG. 16 illustrates another embodiment where a similar rectangular-shaped ventilation slot 210 is formed in a circular flange 202.

As noted above, some embodiments may have ventilation slots formed in the circular flanges formed on both side faces of the compressor rotor. In these embodiments, the ventilation slots may be mirror images of each other on both side faces. Alternatively, although the same number of ventilation slots are provided on both side faces, the ventilation slots located in the circular flange on the first side face of the compressor rotor may be circumferentially offset from the ventilation slots located on the circular flange on the second side face of the rotor. In still other embodiments, a greater number of ventilation slots may be provided on a first face of the compressor rotor than on the second face of the rotor.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A compressor rotor for a turbine engine, comprising:
a disc of material having first and second circular faces;
a circular flange that protrudes outward from the first circular face of the disc adjacent an outer edge of the disc; and
at least one ventilation slot located in the circular flange, the at least one ventilation slot having a longitudinal axis that extends substantially in a radial direction of the disc.

2. The compressor rotor of claim 1, wherein the at least one ventilation slot comprises first and second ventilation slots that are formed on opposite sides of the circular flange.

3. The compressor rotor of claim 1, wherein the at least one ventilation slot comprises a plurality of ventilation slots.

4. The compressor rotor of claim 3, wherein the plurality of ventilation slots are located substantially symmetrically around a circumference of the circular flange.

5. The compressor rotor of claim 3, wherein the plurality of ventilation slots are located substantially asymmetrically around a circumference of the circular flange.

6. The compressor rotor of claim 1, wherein a radially inner end of the at least one ventilation slot is larger than a radially outer end of the at least one ventilation slot.

7. The compressor rotor of claim 6, wherein a width of the at least one ventilation slot becomes gradually smaller from the radially inner end to the radially outer end.

8. The compressor rotor of claim 1, wherein the at least one ventilation slot comprises a depression formed on an outer surface of the circular flange.

9. The compressor rotor of claim 8, wherein the at least one ventilation slot has a semi-circular profile.

10. The compressor rotor of claim 8, wherein the at least one ventilation slot has a V-shaped profile.

11. The compressor rotor of claim 1, wherein the at least one ventilation slot has a square or rectangular shaped profile.

12. The compressor rotor of claim 1, wherein the at least one ventilation slot comprises a passageway that extends through the circular flange from a radially inner surface of the circular flange to a radially outer surface of the circular flange.

13. The compressor rotor of claim 12, wherein the size of the passageway varies along a length of the passageway.

14. The compressor rotor of claim 1, wherein the circular flange on the first circular face comprises a first circular flange, the compressor rotor further comprising:
a second circular flange that protrudes outward from the second circular face of the disc adjacent an outer edge of the disc; and
at least one ventilation slot located in the second circular flange, the at least one ventilation slot having a longitudinal axis that extends substantially in a radial direction of the disc.

15. The compressor rotor of claim 14, wherein the at least one ventilation slot located in the first circular flange is offset circumferentially from the at least one ventilation slot located in the second circular flange.

16. A method of manufacturing a compressor rotor for a turbine engine, comprising:
forming a disc of material having first and second circular faces and a circular flange that protrudes outward from the first circular face of the disc adjacent an outer edge of the disc; and
forming at least one ventilation slot in the circular flange, the at least one ventilation slot having a longitudinal axis that extends substantially in a radial direction of the disc.

17. The method of claim 16, wherein the step of forming at least one ventilation slot comprises forming a plurality of ventilation slots in the circular flange.

18. The method of claim 17, further comprising forming the plurality of ventilation slots symmetrically around the circumference of the circular flange.

19. The method of claim 16, wherein the step of forming at least one ventilation slot comprises forming the at least one ventilation slot such that a radially inner end of the at least one ventilation slot is larger than a radially outer end.

20. The method of claim 16, wherein the circular flange on the first circular face of the disc comprises a first circular flange, wherein step of forming the disc further comprises forming a second circular flange that protrudes outward from the second circular face of the disc adjacent the outer edge of the disc, and further comprising forming at least one ventilation slot in the second circular flange, the at least one ventilation slot having a longitudinal axis that extends substantially in a radial direction of the disc.
